(19) United States
(12) Patent Application Publication
(10) Pub. No.: US 2026/0003419 A1
(43) Pub. Date: Jan. 1, 2026

(54) ELECTRONIC DEVICE

(71) Applicant: Lenovo (Beijing) Limited, Beijing (CN)

(72) Inventors: Jianming LIU, Beijing (CN); Yintian LIU, Beijing (CN); Xinmeng YE, Beijing (CN)

(21) Appl. No.: 19/245,228

(22) Filed: Jun. 20, 2025

(30) Foreign Application Priority Data
Jun. 28, 2024 (CN) 202410869257.4

(51) Int. Cl. G06F 1/3234; G02B 27/01; G06F 1/16; G06F 1/20

(52) U.S. Cl. CPC G06F 1/3234; G02B 27/0172; G06F 1/1643; G06F 1/1656; G06F 1/1669; G06F 1/1677; G06F 1/1686; G06F 1/203; G02B 2027/0178

(57) ABSTRACT

The present disclosure provides an electronic device, including: a first body, having a first storage space; a host system, arranged in the first storage space; and a storage structure, movably arranged in the first storage space, for storing auxiliary input/output components of the electronic device, the storage structure being movable relative to the first body between a storage state and an extended state, where a state switching of the storage structure triggers the host system to switch between a first operating state and a second operating state; or, a switching of the host system between the first operating state and the second operating state triggers the state switching of the storage structure, and where energy consumption and/or authority of the host system at the first operating state is less than energy consumption and/or authority at the second operating state.

### RELATED APPLICATION(S)

This application claims priority to Chinese Patent Application No. 202410869257.4 filed with the China National Intellectual Property Administration on Jun. 28, 2024, which is incorporated herein by reference in entirety.

### FIELD OF THE TECHNOLOGY

The present disclosure relates to the technical field of electronic equipment, and in particular to an electronic device.

### BACKGROUND

When using an electronic device, there may be a situation where an auxiliary component is used in conjunction with a host system of the electronic device. The electronic device includes a main body with the host system. In general, the auxiliary component is positioned separately from the main body and is taken out when needed.

### SUMMARY

In one aspect, the present disclosure provides an electronic device.

The electronic device includes a first body, having a first storage space; a host system, arranged in the first storage space; and a storage structure, movably arranged in the first storage space, for storing auxiliary input/output components of the electronic device, the storage structure being movable relative to the first body between a storage state and an extended state. A state switching of the storage structure triggers the host system to switch between a first operating state and a second operating state. Or, a switching of the host system between the first operating state and the second operating state triggers the state switching of the storage structure. Energy consumption and/or authority of the host system at the first operating state is less than energy consumption and/or authority at the second operating state.

In another aspect, the present disclosure provides an electronic device. The electronic device includes a first body, having a first storage space; a host system, arranged in the first storage space; and a storage structure, being movable relative to the first body between a storage state and an extended state, where a state switching of the storage structure triggers the host system to switch between a first operating state and a second operating state; or, a switching of the host system between the first operating state and the second operating state triggers the state switching of the storage structure.

In yet another aspect, the present disclosure provides a method of operating an electronic device. The method includes providing the electronic device, where the electronic device includes a first body, having a first storage space; a host system, arranged in the first storage space; and a storage structure, being movable relative to the first body between a storage state and an extended state, wherein a state switching of the storage structure triggers the host system to switch between a first operating state and a second operating state; or, a switching of the host system between the first operating state and the second operating state triggers the state switching of the storage structure.

### BRIEF DESCRIPTION OF THE DRAWINGS

In order to more clearly illustrate the embodiments of the present disclosure, figures/drawings are introduced below. The drawings as described are only directed to certain embodiments of the present disclosure. Other suitable drawings may be obtained based on the drawings as describe, without having to incur creative work.

FIG. 1 is a schematic diagram of an electronic device in a first device form, according to certain embodiments of the present disclosure;

FIG. 2 is a schematic diagram of an electronic device in a decomposed structure, according to certain embodiments of the present disclosure;

FIG. 3 is a schematic diagram of an electronic device in a second device form, according to certain embodiments of the present disclosure provided in the embodiment of the present application;

FIG. 4 is a schematic diagram of the structure of the rising state of the camera module according to certain embodiments of the present disclosure;

FIG. 5 is a schematic diagram of the coordination structure of the camera module and the first drive component according to certain embodiments of the present disclosure;

FIG. 6 is a schematic diagram of the gesture structure according to certain embodiments of the present disclosure;

FIG. 7 is a schematic diagram of smart glasses in a decomposed structure, according to certain embodiments of the present disclosure;

FIG. 8 is a schematic diagram of smart glasses in a fourth device form, according to certain embodiments of the present disclosure;

FIG. 9 is a schematic diagram of smart glasses in first partial structure, according to certain embodiments of the present disclosure; and

FIG. 10 is a schematic diagram of smart glasses in second partial structure, according to certain embodiments of the present disclosure.

### DETAILED DESCRIPTION

The present disclosure in certain embodiments provides an electronic device for use by a target operator.

The technical solution in certain embodiments of the present disclosure is described in conjunction with the drawings. The embodiments as described do not necessarily reflect all embodiments of the present disclosure. Based on the embodiments as described, other suitable embodiments may be obtained and are within the scope of protection of the present disclosure.

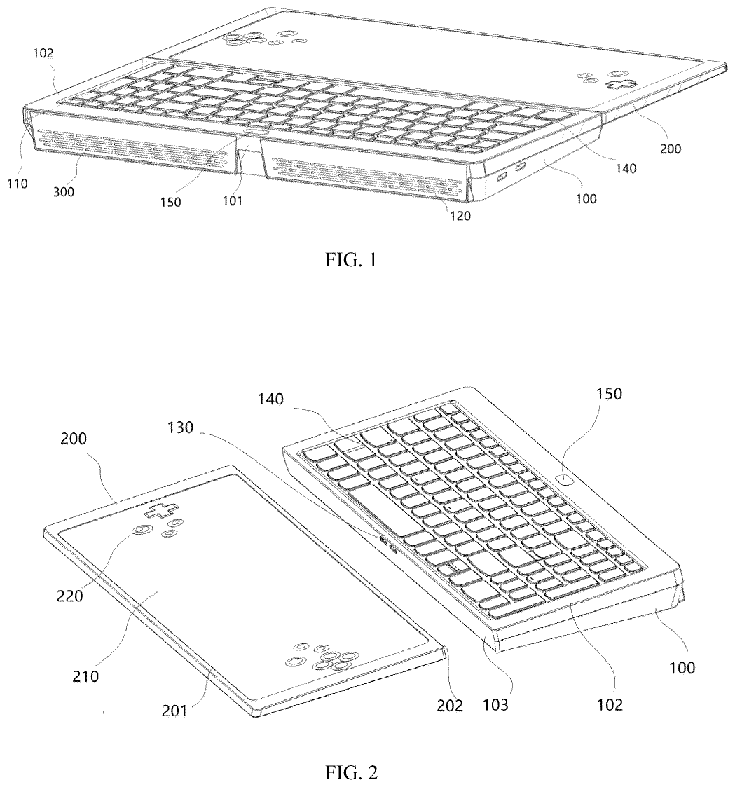

As shown in FIG. 1, present disclosure in certain embodiments provides an electronic device, including a first body 100, a host system, and a storage structure 300,

The first body 100 has a first storage space; the host system is arranged in the first storage space; the storage structure 300 is movably arranged in the first storage space for storing auxiliary input/output components of the electronic device, and the storage structure 300 may move relative to the first body 100 and have a storage state and an extended state. In certain embodiments, the storage structure 300 moves relative to the first body 100 and is in a storage state. Since the host system is set in the first storage space, the auxiliary input/output components placed in the storage structure 300 are also placed in the first storage space, thereby realizing the operation of storing the auxiliary input/output components in the first storage space of the first body 100, so as to avoid misplacement of the auxiliary input/output components caused by placing the auxiliary input/output components separately or the inconvenience when the auxiliary input/output components are stored separately. The storage structure 300 moves relative to the first body 100 and is in an extended state, so that the auxiliary input/output component may be moved out of or into the storage structure 300, so that when the auxiliary input/output component is called for, the auxiliary input/output component may be taken out of the storage structure 300 and used, and when the auxiliary input/output component is not called for, the auxiliary input/output component may be placed in the storage structure 300 to avoid possible loss and facilitate next use.

In certain embodiments, the state switching of the storage structure 300 may trigger the host system to switch between the first operating state and the second operating state; or, the switching of the host system between the first operating state and the second operating state may trigger the state switching of the storage structure 300; that is, the state switching of the storage structure 300 is associated with the operating state of the host system, so that the target operator may switch to another state after executing a state switching operation, which is convenient for the target operator to use.

In certain embodiments, the energy consumption and/or authority of the host system in the first operating state is less than the energy consumption and/or authority of the host system in the second operating state.

The host system may include one or more systems such as a CPU, a hard disk, and a network card that support the normal operation of the electronic device. No specific restrictions are made here, and decisions may be made according to a particular use of the electronic device.

The storage structure 300 may be used as a storage bin to accommodate auxiliary input/output components; the storage structure 300 may also be a bracket to support auxiliary input/output components, or may be any other suitable structures, and the specific structure depends on the type of auxiliary input/output components. In certain embodiments, the storage structure 300 may be determined according to the auxiliary input/output components that need to be stored. In certain embodiments, when the auxiliary input/output components are small objects or objects that are difficult to locate, a storage bin may be used to store them; when the auxiliary input/output components are objects for which any collision is to be avoided, a bracket may be used to position and support the objects. In certain embodiments, a bracket or positioning structure that may position the auxiliary input/output components may be set in the storage bin.

In certain embodiments, the auxiliary input/output component may be smart glasses, TWS (True Wireless Stereo) headphones, microphones, remote controls, or the like, or may be smart interactive terminals, such as smart rings, or the like.

The electronic device according to certain embodiments of the present disclosure may realize the storage and removal of the auxiliary input/output component relative to the first body 100, and the state switching of the storage structure 300 storing the auxiliary input/output component is associated with the operating state of the host system, so as to facilitate the use by the target operator.

In certain embodiments, the energy consumption and/or authority of the host system in the first operating state is less than the energy consumption and/or authority in the second operating state, including that the energy consumption of the host system in the first operating state is less than that in the second operating state, such as the host system is in a shutdown state or a sleep state in the first operating state, while the host system is in a use state in the second operating state. In certain embodiments, the authority of the host system in the first operating state is less than the authority in the second operating state, such as the host system is in a sleep state in the first operating state, while being in a working state in the second operating state. In certain embodiments, the energy consumption and authority of the host system in the first operating state are less than the energy consumption and the authority in the second operating state.

In certain embodiments, the host system in the first operating state may correspond to the storage state of the storage structure 300, and the host system in the second operating state may correspond to the extended state of the storage structure 300. In certain embodiments, the host system in the first operating state may correspond to a switch of the storage structure 300 from the extended state to the storage state, the host system in the second operating state may correspond to a switch of the storage structure 300 from the storage state to the extended state. The operating state of the host system may correspond to the extended state and the storage state of the storage structure 300, and may also correspond to the switching state of the storage structure 300 between the extended state and the stored state. In certain embodiments, the host system may also correspond to the removal state and insertion state of the auxiliary input/output component in the storage structure 300 relative to the storage structure 300.

In certain embodiments, the state switching of the storage structure 300 may include the switching of the storage structure 300 relative to the first body 100 between the storage state and the extended state, and may include the switching of the auxiliary input/output component in the storage structure 300 relative to the storage structure 300 between the removal state and the insertion state.

In certain embodiments, the state switching of the storage structure 300 may trigger the host system to switch between the first operating state and the second operating state.

In certain embodiments, the storage structure 300 is connected to the host system signal; where, the switching of the storage structure 300 between the storage state and the extended state may generate different trigger signals to trigger the host system to switch between the first operating state and the second operating state.

In certain embodiments, the storage structure 300 may have a touch switch, and the touch switch of the storage structure 300 may move with the telescopic state of the storage structure 300. In certain embodiments, during the switching of the storage structure 300 between the storage state and the extended state, the touch switch may move relative to the first body 100, and may generate a corresponding trigger signal by contacting and separating the physical structure of the first body 100, so that the trigger signal triggers the host system to switch between the first operating state and the second operating state. In certain embodiments, during the switching of the storage structure 300 from the extended state to the storage state, the touch switch contacts the physical structure of the first body 100 and generates a trigger signal, triggering the host system to switch from the second operating state to the first operating state.

In certain embodiments, a position sensor may be provided. As the storage structure 300 moves in the telescopic state, the position of the storage structure 300 relative to the first body 100 changes. The position sensor generates a trigger signal based on the position information of the storage structure 300 to trigger the host system to switch between the first operating state and the second operating state. Other structures may also be provided so that the storage structure 300 may generate different trigger signals when switching between the storage state and the extended state. No restrictions are made to the type of sensor and any suitable sensors are within the scope of protection.

In certain embodiments, the storage structure 300 is connected to the host system signal; where, at least one first detection element is arranged in the storage structure 300, and the first detection element may detect the placement status of the auxiliary input/output component in the storage structure 300 and generate different trigger signals, and the trigger signal may trigger the host system to switch between the first operating state and the second operating state.

In certain embodiments, the first detection element may be a position detection device, which is used to detect whether there is an auxiliary input/output component in the storage structure 300. When the position detection device detects that the auxiliary input/output component is not in the storage structure 300, it is determined that the auxiliary input/output component is in a state of being taken out from the storage structure 300. When the position detection device detects that the auxiliary input/output component is in the storage structure 300, it is determined that the auxiliary input/output component is in a state of being placed in the storage structure 300. The position detection device uses the detected signal as a trigger signal to trigger the host system to switch between the first operating state and the second operating state. In certain embodiments, when the position detection device detects that the auxiliary input/output component is in the storage structure 300, the detection signal of the position detection device is used as a trigger signal to trigger the host system to switch from the second operating state to the first operating state.

In certain embodiments, the first detection element may be a gravity detection device, which determines the access state of the auxiliary input/output component in the storage structure 300 by detecting the total weight of the storage structure 300 or the position where the auxiliary input/output component is placed in the storage structure 300. Other structures may also be provided so that the switching of the access state of the auxiliary input/output component in the storage structure 300 (switching between the taking-out state and the putting-in state) may generate different trigger signals. No restrictions are made to the type of the detection devices, and any suitable detection devices are within the scope of protection.

In certain embodiments, the storage structure 300 is connected to the host system signal to realize the transmission of the trigger signal. The signal connection may be a wired connection, that is, the trigger signal is transmitted through a signal line; the signal connection may also be a wireless connection, that is, the transmission of the trigger signal is realized through devices such as Wi-Fi or Bluetooth.

As shown in FIGS. 1 and 2, in the electronic device provided in certain embodiments of the present disclosure, the first body 100 includes a first wall 101, a second wall 102 and a third wall 103 that enclose and form a first storage space.

The first wall 101 and the third wall 103 are arranged at two opposite sides of the second wall 102, and the angle between the plane where the first wall 101 is located and the plane where the second wall 102 is located is smaller than the angle between the plane where the second wall 102 is located and the plane where the third wall 103 is located.

In certain embodiments, in a normal use state, the first wall 101 may be a side facing the target operator, the third wall 103 may be a side facing away from the target operator, and the second wall 102 may be a side connecting the first wall 101 and the third wall 103. In certain embodiments, the second wall 102 faces upward. By limiting the size of the angle, the space surrounded by the first wall 101, the second wall 102 and the third wall 103 is not an axisymmetric structure. In a state where the plane where the first wall 101 and the plane where the third wall 103 are located are placed vertically, the second wall 102 may be tilted downward in a direction away from the target operator. That is, the cross section of the first body 100 (the cross section along the arrangement direction of the first wall 101, the second wall 102 and the third wall 103) is of a trapezoidal shape, so that the target operator may understand the placement direction of the first body 100 through the appearance.

In certain embodiments, the first wall 101 is provided with a first opening 110 connected to the first storage space, and the storage structure 300 is stored or extended from the first body 100 through the first opening 110. That is, the first opening 110 serves as an outlet for the storage structure 300 to switch between the stored state and the extended state. In the extended state, the storage structure 300 may be partially or completely extended from the first opening 110; in the storage state, the storage structure 300 may be stored in the first storage space through the first opening 110.

In certain embodiments, and to facilitate the storage structure 300 to switch between the storage state and the extended state, a sliding structure may be set between the first body 100 and the storage structure 300, so that the storage structure 300 may slide with the first body 100 through the sliding structure.

In certain embodiments, the first body 100 includes a fourth wall (not shown), which connects the first wall 101 and the third wall 103 and is arranged opposite to the second wall 102. That is, the first wall 101, the second wall 102, the third wall 103 and the fourth wall are sequentially connected to form the peripheral structure of the first storage space, and the four sides of the cross section (trapezoidal shape) of the first body 100 correspond to the first wall 101, the second wall 102, the third wall 103 and the fourth wall, respectively.

In certain embodiments, the first body 100 includes a fifth wall and a sixth wall. The fifth wall is connected to one side of the first wall 101, the second wall 102, the third wall 103 and the fourth wall, and the sixth wall is connected to the other side of the first wall 101, the second wall 102, the third wall 103 and the fourth wall, so that the first wall 101, the second wall 102, the third wall 103, the fourth wall, the fifth wall and the sixth wall form a hexahedral structure.

In certain embodiments, the first wall 101 is provided with a first heat dissipation area 120, which may be arranged on the first wall 101, and the first heat dissipation area 120 is provided with a plurality of second openings for heat dissipation of the host system. In certain embodiments, there is a center line of the first wall 101 (located in the plane where the first wall 101 is located), the first opening 110 and the first heat dissipation area 120 are respectively arranged on either sides of the center line of the first wall 101. In certain embodiments, the auxiliary input/output component placed in the storage structure 300 may be glasses (smart glasses, myopia glasses or reading glasses, or the like), and by symmetrically arranging the first opening 110 and the first heat dissipation area 120, which together imitate the two lenses of the glasses to guide or hint the target operator. In certain embodiments, eyeglasses are stored in the storage structure 300.

In certain embodiments, the first opening 110 and the first heat dissipation area 120 may be set as a convex structure that bulges outward from the first storage space, so that other areas of the first wall 101 (including the area between the first opening 110 and the first heat dissipation area 120) form a recessed structure, imitating the frame structure of eyeglasses, so that the appearance of the first wall 101 is in the shape of the glasses body (the glasses without the temples).

The first opening 110 and the first heat dissipation area 120 may also be set as a concave structure that is concave into the first storage space, so that other areas of the first wall 101 are convex, and the frame structure of the imitation eyeglasses makes the appearance of the first wall 101 in the form of a glasses body (glasses without the temples).

The fifth wall and the sixth wall may also be provided with a pattern of imitation temples to facilitate the appearance of the first wall 101 in the form of glasses.

In certain embodiments, the storage structure 300 is a slot structure with a second storage space, and the slot structure includes a first slot wall and a second slot wall that are arranged opposite to the plane where the first wall 101 is located, and the height of the first slot wall in the first direction is greater than the height of the second slot wall in the first direction, and the first direction is a direction parallel to the plane where the first wall 101 is located. That is, the cross section of the slot structure (the cross section along the arrangement direction of the first wall 101, the second wall 102 and the third wall 103) is a trapezoidal structure. In the process of the storage structure 300 switching from the extended state to the storage state relative to the first body 100, the second slot wall is a surface facing the moving direction. That is, in the storage state, the second slot wall is away from the first opening 110, and the first slot wall is close to the first opening 110. That is, the smaller-sized end (second slot wall) of the storage structure 300 is inserted into the first storage space from the first opening 110, and the larger-sized end (first slot wall) of the storage structure 300 is close to the first opening 110, so as to facilitate the placement of the auxiliary input/output component relative to the second storage space.

In certain embodiments, the cross section of the first body 100 is of a trapezoidal shape, which may make the height of the first wall 101 in the first direction greater than the height of the third wall 103 in the first direction. By setting the storage structure 300 as the slot structure, the storage structure 300 and the first body 100 may be more engaged, and the first storage space of the first body 100 may be reasonably used.

In certain embodiments, the storage structure 300 may be set as a bracket structure.

In certain embodiments, the slot structure includes a third slot wall adjacent to the first slot wall and the second slot wall, and the first slot wall, the third slot wall and the second slot wall enclose a second storage space. In certain embodiments, the upper edge of the third slot wall is parallel to the plane where the second wall 102 is located. It may be understood that the slot structure also has a slot bottom surface, and the upper edge of the third slot wall is the opening edge of the slot structure. The space between the second wall 102 and the slot structure (the upper edge of the third slot wall) may be reasonably planned to facilitate the arrangement of structures with uniform thickness (such as a circuit board or a keyboard, or the like).

In certain embodiments, the first surface of the second wall 102 is further provided with a first keyboard area 140, which is used to send a corresponding first input signal to the host system in response to the first input operation of the target operator. The first keyboard area 140 may be a physical keyboard or a virtual keyboard. The target operator may send the corresponding first input signal to the host system through the first keyboard area 140, so as to control the host system accordingly.

The first input signal may include a control signal for controlling the operating state of the host system. In certain embodiments, where the host system switches between the first operating state and the second operating state to trigger the state switching of the storage structure, the host system switches between the first operating state and the second operating state through the first input signal to trigger the state switching of the storage structure. The control signal may be a signal for controlling the host system to be turned on and off, or other signals.

The first keyboard area 140 may trigger different input signals based on the key operation of the target operator on the keyboard, such as a string data signal or a control instruction generated after a combination key or a shortcut key is triggered.

As shown in FIG. 4 and FIG. 5, the edge area of the second wall 102 near the first wall 101 is also provided with a third opening 150 connected to the first storage space, and the electronic device also includes a camera module 400, and the camera module 400 may be lifted and lowered relative to the first body 100 through the third opening 150 to extend out of the plane where the second wall 102 is located or be stored in the first storage space. In certain embodiments, the camera module 400 may be used as a collection module for collecting the body state information of the target operator, and the electronic device is controlled accordingly according to the body state of the target operator. The body state of the target operator may include the control gesture of the target operator, the physical state of the target operator (such as states of standing, walking, sitting, or lying) and the physiological state of the target operator (such as states of being awake, sleeping, and being fatigued), and the electronic device is controlled according to the body state information of the target operator, which may improve the interactivity between the electronic device and the target operator.

In certain embodiments, the third opening 150 may be arranged in the middle of the edge area of the second wall 102 close to the first wall 101, so that the third opening 150 corresponds to the area between the first opening 110 and the first heat dissipation area 120 in the vertical direction. When the area between the first opening 110 and the first heat dissipation area 120 is a concave structure that is concave relative to the first opening 110 and the first heat dissipation area 120, blockage of the first wall 101 on the collection area of the camera module 400 raised through the third opening 150 may be reduced.

In certain embodiments, when the camera module 400 is lowered relative to the third opening 150, the top surface of the camera module 400 may close the third opening 150, so that the second wall 102 is a closed wall, preventing external dust or impurities from entering the first storage space.

In certain embodiments, the shape of the third opening 150 depends on the structure of the camera module 400, and no restrictions are made to the structure of the camera module 400.

The electronic device also includes a first drive component 500 for driving the camera module 400 to be raised or lowered, and the first drive component 500 is connected to the storage structure 300 by signal. The first drive component 500 may be controlled by switching the state of the storage structure 300, so as to perform raising and lowering motion on the camera module 400. In certain embodiments, when the storage structure 300 moves to the extended state relative to the first body 100 or the auxiliary input/output component is removed from the storage structure 300, the switching of the state of the storage structure 300 triggers the operation of the first drive component 500 through the signal connection between the first drive component 500 and the storage structure 300, so that the first drive component 500 drives the camera module 400 to be raised; when the storage structure 300 moves to the storage state relative to the first body 100 or the auxiliary input/output component is placed in the storage structure 300, the switching of the state of the storage structure 300 triggers the operation of the first drive component 500 through the signal connection between the first drive component 500 and the storage structure 300, so that the first drive component 500 drives the camera module 400 to be lowered. These configurations facilitate the target operator to use the electronic device.

In certain embodiments, the switching of the storage structure 300 between the storage state and the extended state may generate different trigger signals to trigger the first drive component 500 to drive the camera module 400 to be in the storage state or the extended state. The switching between the extended state and the storage state of the storage structure 300 relative to the first body 100 is used as the operation to trigger the first drive component 500. As shown in FIG. 5, the trigger signal is generated by the position change of the storage structure 300 (the sliding of the storage bin). When the first drive component 500 includes a position detection device, the trigger signal may be a position signal formed by the position detection device detecting the position change of the storage structure 300; when the first drive component 500 may include a control switch, the control switch may be pressed or touched by the position change of the storage structure 300, and the trigger signal is the control signal of the control switch.

In certain embodiments, at least one second detection element provided in the storage structure 300 may detect the placement state of the auxiliary input/output component in the storage structure 300 and generate different trigger signals, and the trigger signals may trigger the first drive component 500 to drive the camera module 400 to be in the storage state or the extended state. The switching of the auxiliary input/output component between the removal state and the insertion state relative to the storage structure 300 is used as the triggering operation of the first drive component 500, and the signal for controlling the operation of the first drive component 500 may be triggered by detecting the placement state of the auxiliary input/output component. The second detection element may be a position detection device or a gravity detection device as described herein elsewhere.

In certain embodiments, the camera module 400 may have an HPD (Hot Plug Detect) component and a DSP (Digital Signal Processor) component to facilitate the adaptation of the AR (Augmented Reality) display function.

In certain embodiments, the first detection element and the second detection element may be the same detection element. The host system is controlled to switch between the first operating state and the second operating state and the camera module 400 is driven to be in the storage state or the extended state. In certain embodiments, the first detection element and the second detection element may also be relatively independent from each other, and the host system and the camera module 400 may be relatively independently controlled.

In certain embodiments, the first drive assembly 500 also includes a drive structure for driving the camera module 400, and the drive structure is connected by devices such as position detection device or control switch that generate the trigger signal. The drive structure may be a structure such as a lifting cylinder, a gear rack assembly or a drive motor, so as to apply a lifting drive force to the camera module 400.

In certain embodiments, the state of the camera module 400 may also be controlled according to the host operating state. The first drive assembly 500 may be connected to the host system signal, and the host system may generate different trigger signals by switching between the first operating state and the second operating state to trigger the first drive assembly 500 to drive the camera module to be in the storage state or the extended state.

In certain embodiments, the camera module 400 is connected to the host system signal and may respond to the target gesture of the target operator and send the corresponding target control instruction to the host system. The target control instruction may include gesture control or body control, or the like.

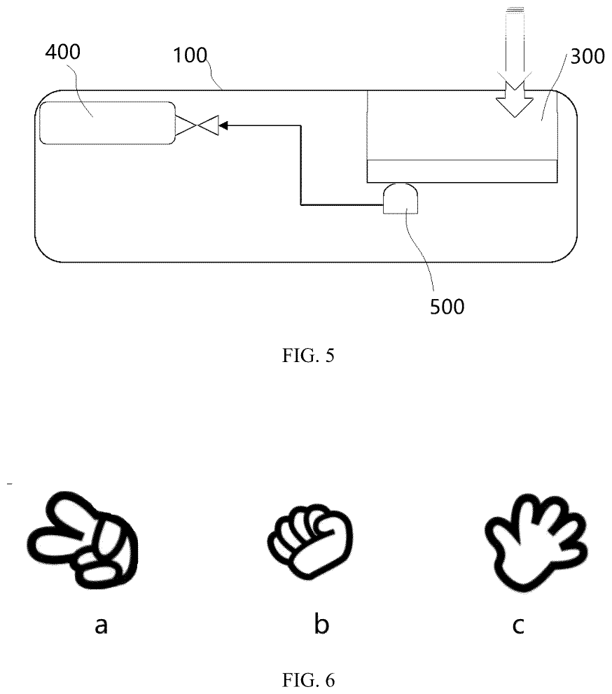

Taking gesture control as an example, as shown in FIG. 6, when the auxiliary input/output component is a pair of smart glasses, the split screen operation may be realized by gesture a, the merge screen operation may be realized by gesture b, and the switching screen operation may be realized by gesture c, so that the target operator may control the electronic device.

As shown in FIGS. 1, 2 and 3, the electronic device includes a second body 200, and the second body 200 includes a seventh wall 201 and an eighth wall 202 arranged adjacently; the second body 200 cooperates with the first body 100 to enable the electronic device to have a first device form and a second device form;

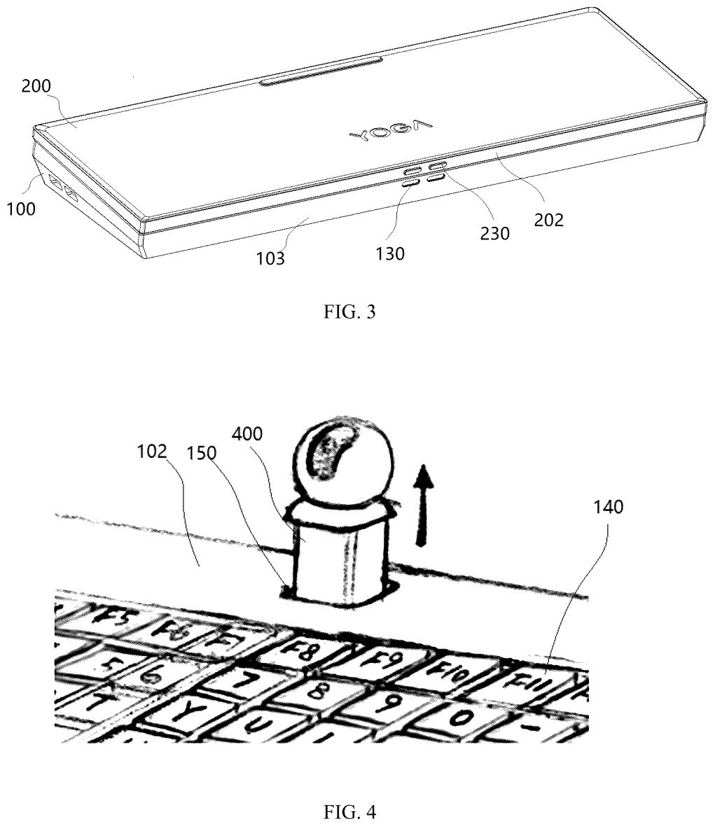

As shown in FIGS. 2 and 3, in the first device form, the second body 200 is placed on top of the first body 100, and the second wall 102 of the first body 100 is arranged opposite to the seventh wall 201;

In certain embodiments, and in the first device form, there is no signal connection between the first body 100 and the second body 200; in the second device form, there is a signal connection between the first body 100 and the second body 200. In the first device form, the first body 100 and the second body 200 are in a relatively stacked state, which is the storage state of the electronic device provided in certain embodiments of the present disclosure, so as to reduce the overall size, and in the non-working state, the second body 200 may cover the first keyboard area 140 of the first body 100 to prevent dust from entering the first keyboard area 140. In the second device form, the first body 100 and the second body 200 are in a relatively unfolded and connected state, so as to facilitate user use.

As shown in FIG. 1, in the second device form, the third wall 103 of the first body 100 is in contact with the eighth wall 202, and the plane where the seventh wall 201 is located is the same as the plane where the second wall 102 is located.

In certain embodiments, the cross section of the second body 200 is of a trapezoidal shape. The larger-size end of the second body 200 is where the eighth wall 202 is located. In the second device form, the first body 100 and the second body 200 form a wedge-shaped structure with a thickness decreasing from the first body 100 to the second body 200. Furthermore, the inclination angle of the seventh wall 201 is consistent with the inclination angle of the second wall 102, so that the operating surface of the entire electronic device is a smooth inclined surface.

In certain embodiments, in the first device form, the larger-size end of the second body 200 may correspond to the third wall 103 of the first body 100 (the smaller-size end of the first body 100), forming a structure close to a rectangular body.

In certain embodiments, the third wall 103 of the first body 100 is provided with a first input-output structure 130 connected to the host system, and the eighth wall 202 is provided with a second input-output structure 230 corresponding to the first input-output structure 130. In the second device form, the first body 100 and the second body 200 are connected by signals through the first input-output structure 130 and the second input-output structure 230. In certain embodiments, one of the first input-output structure 130 and the second input-output structure 230 is an interface structure, and the other is a plug-in port. Through this arrangement, the structural stability in the second device form may be further improved. In certain embodiments, the host system of the first body 100 and the second body 200 may be connected wirelessly. The interface structure may be a USB (Universal Serial Bus), a TBT interface (Thunderbolt interface), a POGO PIN (Spring LOAADED Contact Pin), or the like.

In certain embodiments, the first body 100 and the second body 200 are docked, and in the first device form, the first body 100 and the second body 200 may be positioned in a relatively stacked state by employing a magnetic attraction member or a positioning connector. In the second device form, the first body 100 and the second body 200 may be positioned in a relatively unfolded state by employing a magnetic attraction member or a positioning connector.

In certain embodiments, the second surface of the seventh wall 201 is provided with a first touchpad area 210 and at least one touch control 220, which may respond to the second input operation acting on the first touchpad area 210 and/or the touch control 220 and send the generated second input signal to the host system. In certain embodiments, the touch control 220 may be a game operation control that implements corresponding operations in the game mode, or a shortcut operation control that implements shortcut operations. In certain embodiments, and for the convenience of touch control, the touch of the touch control 220 is distinguished from the touch of the first touchpad area 210, so that the target operator may perform the positioning of the touch control 220 by touching. The touch control 220 may be a virtual key with a feel, such as a particular texture (a concave-convex structure such as a small particle dot matrix or a corrugated pattern). The touch control 220 may be relatively independent of the first touchpad area 210, or the touch control 220 may be arranged in the first touchpad area 210. The second input signal is transmitted through the signal transmission channel of the first input-output structure 130 and the second input-output structure 230.

In certain embodiments, the first touchpad area 210 may form a second keyboard area to be used as a keyboard.

In certain embodiments, the auxiliary input/output component includes a pair of smart glasses; the smart glasses may establish a signal connection with the host system to present the target display content provided by the host system to the wearer. The smart glasses may be AR (Augmented Reality) glasses.

In certain embodiments, the host system may adjust the output parameters of the target display content provided to the smart glasses in response to the input operation obtained by at least one of the camera module 400, keyboard, touchpad or touch control 220 of the electronic device. In certain embodiments, the keyboard may include the first keyboard area 140. In certain embodiments, the touchpad may include the first touchpad area 210. The output parameters may include display content, resolution, frame rate, refresh rate, picture angle, or the like.

In the second device form, the second body 200 and the walls corresponding to the fifth wall and the sixth wall of the first body 100 may be provided with patterns of imitation temples. The configuration that the second body 200 and the first body 100 may be separated helps serve as a reminder or implication that the target operator may disassemble the smart glasses. In certain embodiments, when the electronic device is in use, the second body 200 and the first body 100 are in the first device form, and the second body 200 and the first body 100 may cooperate to present the form of glasses.

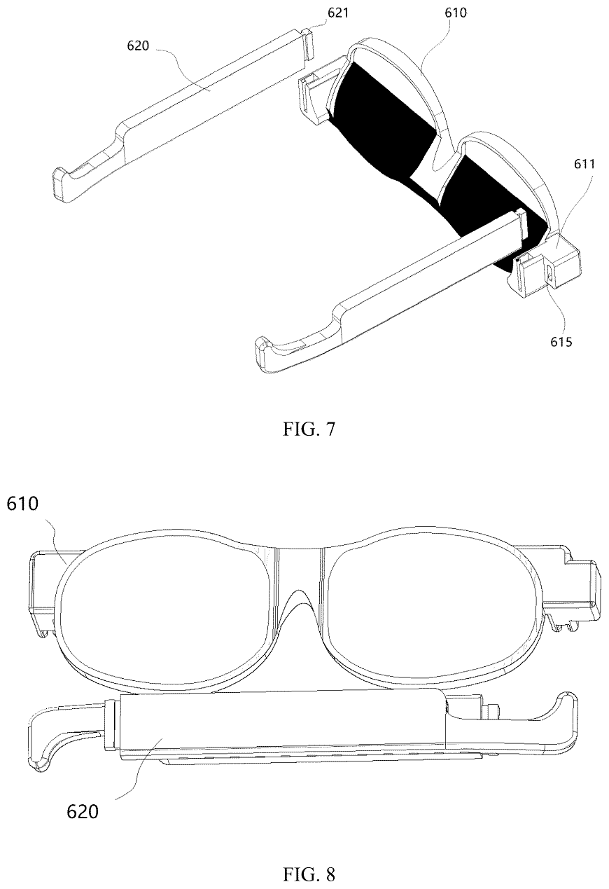

As shown in FIGS. 7 and 8, the smart glasses include: a third body 610, the third body 610 has an optical device, the optical device has an emission surface that allows the wearer to perceive image information; the emission surface is located between the first end of the third body 610 and the second end of the third body 610, and the third body 610 has a first connecting portion 611; a support body 620, and the end of the support body 620 has a second connecting portion 621 that may be detachably connected to the first connecting portion 611;

Where, the third body 610 and the support body 620 may cooperate to have a third device form and a fourth device form;

In the third device form, the first connecting portion 611 is connected to the second connecting portion 621, and the support body 620 engages with the third body 610, which may maintain the relative relationship between the third body 610 and the wearer's head, so that the emission surface faces the wearer's eyes;

In the fourth device form, when the first connecting portion 611 and the second connecting portion 621 are disengaged, the third body 610 and the support body 620 are independent to each other.

In certain embodiments, the support body 620 may be a temple structure, or a structure such as a cable tie that may be fixed to the wearer's head.

In certain embodiments, the smart glasses may switch between the third device form and the fourth device form. In the fourth device form, the third body 610 and the support body 620 are independent to each other, so as to be stacked in the storage structure, thereby reducing the size requirement of the second storage space in the storage structure, thereby facilitating the miniaturization design of the electronic device.

In certain embodiments, taking the support body 620 as a temple as an example, in the fourth device form, the third body 610 and the support body 620 are relatively independent to each other, which may effectively reduce the thickness of the smart glasses.

In certain embodiments, the support body 620 may have control elements to reduce the number of parts provided on the third body 610, reduce the total amount of the third body 610, and improve the comfort of the wearer. In the third device form, there is a signal connection between the third body 610 and the support body 620; in the fourth device form, there is no signal connection between the third body 610 and the support body 620.

In certain embodiments, the third body 610 has a first functional device electrically connected to the optical device, and the support body 620 has a second functional device; the electronic device in certain embodiments of the present disclosure has a transmission component for electrically connecting the first functional device and the second functional device; when the first connecting portion 611 is connected to the second connecting portion 621, the first functional device is electrically connected to the second functional device through the transmission component.

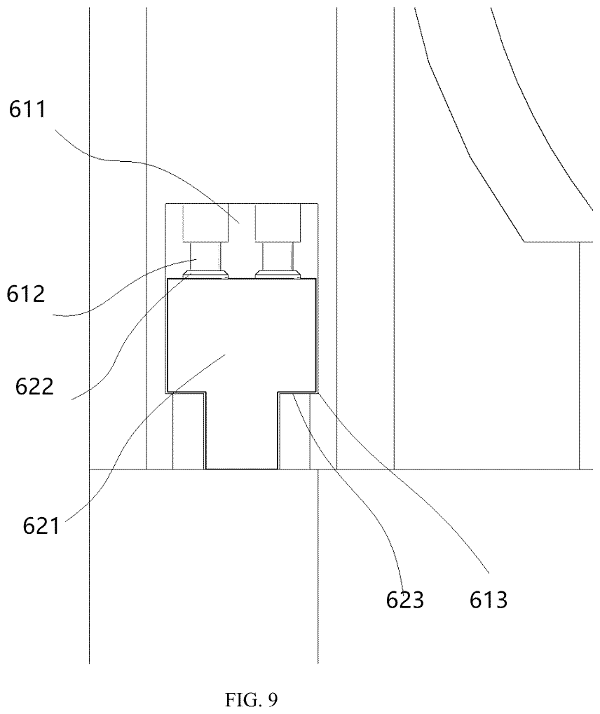

As shown in FIG. 9, the transmission component includes a first transmission part 612 arranged on the first surface of the first connecting portion 611 and a second transmission part 622 arranged on the second surface of the second connecting portion 621; when the first connecting portion 611 and the second connecting portion 621 are connected, the first surface and the second surface are arranged opposite to each other, and the first transmission part 612 and the second transmission part 622 are in conductive contact.

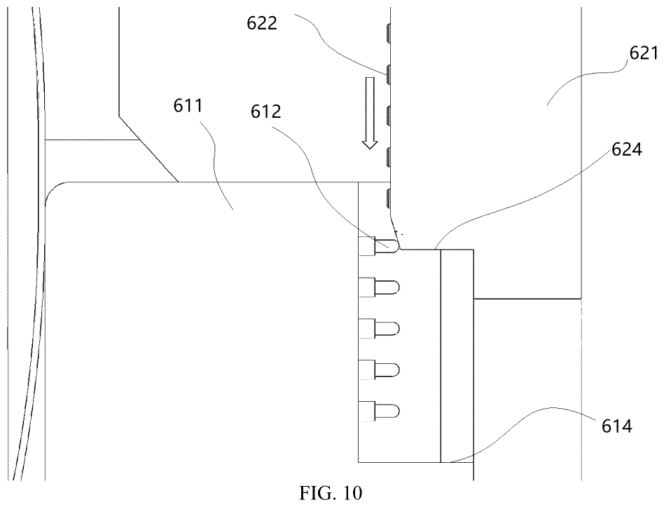

As shown in FIG. 9 and FIG. 10, the first connecting portion 611 is a plug-in slot, and the second connecting portion 621 is a plug-in protrusion plugged into the plug-in slot; the first transmission part 612 may be extended and retracted in a direction perpendicular to the first surface; the intersection of the second support surface 624 of the plug-in protrusion and the second surface has a chamfer, and the chamfered surface may press the end of the first transmission part 612. The connection stability of the first connecting portion 611 and the second connecting portion 621 is thus improved.

In certain embodiments, the first connecting portion 611 has a first limiting surface 613 arranged along an extension direction, and the second connecting portion 621 has a second limiting surface 623 for limiting cooperation with the first limiting surface 613; during the process of connecting the first connecting portion part 611 and the second connecting portion 621, the first limiting surface 613 and the second limiting surface 623 are slidably engaged and reduce moving-away of the support body 620 from the third body 610. In certain embodiments, the cooperation between the first limiting surface 613 and the second limiting surface 623 may limit the relative distance between the first connecting portion 611 and the second connecting portion 621, and further improve the connection stability between the first connecting portion 611 and the second connecting portion 621.

In certain embodiments, the first surface of the first connecting portion 611 is arranged relative to the first limiting surface 613 of the first connecting portion 611; when the first connecting portion 611 is connected to the second connecting portion 621, the second connecting portion 621 is located between the first surface and the first limiting surface 613. The second connecting portion 621 may be positioned in the space formed between the first surface and the first limiting surface 613.

In certain embodiments, the second connecting portion 621 is a “ [symbol] ” shaped structure (a convex shape), and the first connecting portion 611 has a corresponding “ [symbol] ” shaped guide rail, and the connection between the first connecting portion 611 and the second connecting portion 621 is realized by sliding plug-in, which may have the function of guiding and limiting the plug-in direction.

In certain embodiments, and to improve the connection stability between the first connecting portion 611 and the second connecting portion 621 during the engagement process, one end of the first connecting portion 611 has a plug-in opening, which is located at the lower end surface of the third body 610, and the other end of the first connecting portion 611 has a first support surface 614; the second connecting portion 621 has a second support surface 624.

During the engagement process between the first connecting portion 611 and the second connecting portion 621, the second connecting portion 621 is plugged into the first connecting portion 611 from the plug-in opening in the direction close to the first support surface 614, and the first support surface 614 contacts the second support surface 624.

In certain embodiments, the second connecting portion 621 has a chamfered structure (angle C or rounded corner, or the like) on one side facing the first support surface 614, so as to guide the first connecting portion 611 and the second connecting portion 621 to slide relative to each other.

In certain embodiments, the first support body 620 is a temple, the first end of the third body 610 and the second end of the third body 610 both have a first connecting portion 611; the electronic device has two support bodies 620, namely the first support body 620 and the second support body 620; the second connecting portion 621 of the first support body 620 is connected to the first connecting portion 611 of the first end of the third body 610, and the second connecting portion 621 of the second support body 620 is connected to the first connecting portion 611 of the second end of the third body 610. In certain embodiments, the two first support bodies 620 are symmetrically arranged on both sides of the third body 610.

In certain embodiments, when the first support body 620 is of another/different structure, the structures of the first connecting portion 611 and the second connecting portion 621 may be adjusted accordingly.

In certain embodiments, and to improve the wearer's comfort, when the first (or left) support body 620 and the third body 610 are engaged and the second (or right) support body 620 and the third body 610 are engaged, the angle between the first support body 620 and the third body 610 is equal to the angle between the second support body 620 and the third body 610.

In certain embodiments, the angle between the first support body 620 and the third body 610 may be 90°.

In certain embodiments, and to further improve the wearer's comfort, the angle between the first support body 620 and the third body 610 may also be adjusted.

In certain embodiments, and to facilitate the use of smart glasses, the smart glasses may be provided with power supply equipment such as batteries. In certain embodiments, the third body 610 also has a power supply component and an electrical interface 615 electrically connected to the power supply component, and the power supply component is electrically connected to the optical device. The smart glasses may also be used with external power supply, that is, the third body 610 is provided with an electrical interface 615 for connecting to an external power supply device, and the electrical interface is electrically connected to the optical device.

The various embodiments in the present disclosure are described, and one or more embodiments may reflect differences from other embodiments. The same and similar parts between the various embodiments may be referenced to each other.

The description helps enable professionals in the field to implement or use certain embodiments of the present disclosure. Various modifications to the embodiments may be apparent to professionals in the field, and the general principles may be implemented in other embodiments without departing from the spirit or scope of the present disclosure. The present disclosure is not to be limited to the embodiments as described here, but conform to the broadest scope consistent with the principles and features as disclosed.

What is claimed is:

1. An electronic device, comprising:
a first body, having a first storage space;
a host system, arranged in the first storage space; and
a storage structure, movably arranged in the first storage space, for storing auxiliary input/output components of the electronic device, the storage structure being movable relative to the first body between a storage state and an extended state,
wherein a state switching of the storage structure triggers the host system to switch between a first operating state and a second operating state; or, a switching of the host system between the first operating state and the second operating state triggers the state switching of the storage structure,
and wherein energy consumption and/or authority of the host system at the first operating state is less than energy consumption and/or authority at the second operating state.

2. The electronic device of claim 1, wherein the storage structure is connected to the host system via signals, and the switching of the storage structure between the storage state and the extended state generates different trigger signals to trigger the host system to switch between the first operating state and the second operating state,
or
wherein at least one first detection element is provided in the storage structure, and the first detection member detects a placement state of the auxiliary input/output component in the storage structure and generates different trigger signals, and the trigger signals trigger the host system to switch between the first operating state and the second operating state.

3. The electronic device of claim 1, wherein the first body includes a first wall, a second wall and a third wall that enclose and form the first storage space,
the first wall and the third wall are arranged at two opposite edges of the second wall, and an angle between the plane where the first wall is located and the plane where the second wall is located is smaller than an angle between the plane where the second wall is located and the plane where the third wall is located,
and/or,
wherein the first wall is provided with a first opening that is connected to the first storage space, and the storage structure is received or extended from the first body through the first opening.

4. The electronic device of claim 3, wherein the first wall is provided with a first heat dissipation area, and the first heat dissipation area is provided with a plurality of second openings for the host system to dissipate heat,
and/or
wherein the storage structure is a slot structure with a second storage space, the slot structure includes a first slot wall and a second slot wall, a height of the first slot wall in a first direction is greater than a height of the second slot wall in the first direction, and the first direction is a direction parallel to a plane where the first wall is located.

5. The electronic device of claim 3, wherein a first surface of the second wall is provided with a first keyboard area for responding to a first input operation of a target operator and sending a first input signal to the host system,
and/or
wherein an edge area of the second wall is provided with a third opening connected to the first storage space, the electronic device includes a camera module, and the camera module moves up and down relative to the first body through the third opening.

6. The electronic device of claim 5, further comprising:
a first driving component for driving the camera module, and the first driving component is connected to the storage structure via signals,
wherein the switching of the storage structure between the storage state and the extended state generates different trigger signals to trigger the first driving component to drive the camera module,
or
wherein at least one second detection element provided in the storage structure detects an access state of the auxiliary input/output component in the storage structure and generates different trigger signals, and the trigger signals trigger the first driving element to drive the camera module,
or
wherein the camera module is connected to the host system via signals and responds to a target gesture of the target operator and sends a target control instruction to the host system.

7. The electronic device of claim 1, further comprising:
a second body, including a seventh wall and an eighth wall,
wherein a cooperation between the second body and the first body places the electronic device in a first device form or in a second device form,
in the first device form, the second body is positive on top of the first body, and
in the second device form, the third wall of the first body contacts the eighth wall of the second body,
or
in the first device form, there is no signal connection between the first body and the second body,
in the second device form, there is a signal connection between the first body and the second body.

8. The electronic device of claim 7, wherein the third wall of the first body is provided with a first input-output structure connected to the host system, the eighth wall is provided with a second input-output structure corresponding to the first input-output structure, and in the second device form, the first body and the second body are connected by signals through the first input-output structure and the second input-output structure,
or
wherein the seventh wall is provided with a first touchpad area and at least one touch control, and in response to a second input operation acting on the first touchpad area and/or the touch control, a generated second input signal is sent to the host system.

9. The electronic device of claim 1, wherein the auxiliary input/output component includes a pair of smart glasses, configured to establish a signal connection with the host system,
or
wherein the host system is configured to adjust output parameters of target display content provided to the smart glasses in response to an input operation obtained by at least one of a camera module, keyboard, touchpad, or touch control of the electronic device.

10. The electronic device of claim 9, wherein the smart glasses include:
a third body, the third body having an optical device, the optical device having an emission surface that allows a wearer to perceive image information, the emission surface is located between a first end of the third body and a second end of the third body, and the third body has a first connecting portion; and
a support body, an end of the support body having a second connecting portion that is detachably connected to the first connecting portion,
wherein the third body and the support body together present a third device form and a fourth device form,
in the third device form, the first connecting portion is connected to the second connecting portion, and
in the fourth device form, the first connecting portion is disconnected from the second connecting portion,
or
in the third device form, there is a signal connection between the third body and the support body, and
in the fourth device form, there is no signal connection between the third body and the support body.

11. An electronic device, comprising:
a first body, having a first storage space;
a host system, arranged in the first storage space; and
a storage structure, being movable relative to the first body between a storage state and an extended state,
wherein a state switching of the storage structure triggers the host system to switch between a first operating state and a second operating state; or, a switching of the host system between the first operating state and the second operating state triggers the state switching of the storage structure.

12. The electronic device of claim 11, wherein energy consumption and/or authority of the host system at the first operating state differs than energy consumption and/or authority at the second operating state.

13. The electronic device of claim 11, wherein the storage structure is connected to the host system via electronic signals.

14. The electronic device of claim 11, wherein the switching of the storage structure between the storage state and the extended state generates different trigger signals to trigger the host system to switch between the first operating state and the second operating state.

15. The electronic device of claim 11, wherein a first detection element is provided in the storage structure, and the first detection member detects a placement state of auxiliary input/output component in the storage structure and generates different trigger signals, and the trigger signals trigger the host system to switch between the first operating state and the second operating state.

16. The electronic device of claim 11, wherein the first body includes a first wall, a second wall and a third wall that enclose and form the first storage space, and an angle between the first wall and the second wall is smaller than an angle between the second wall and the third wall.

17. The electronic device of claim 11, wherein the first body includes a first wall, a second wall and a third wall that enclose and form the first storage space, and the first wall is provided with a first opening that is connected to the first storage space, and the storage structure is received or extended from the first body through the first opening.

18. The electronic device of claim 11, wherein the first body includes a first wall, a second wall and a third wall that enclose and form the first storage space, the first wall is provided with a first heat dissipation area, and the first heat dissipation area is provided with a plurality of second openings for the host system to dissipate heat.

19. The electronic device of claim 11, wherein the storage structure includes a first slot wall and a second slot wall together defining a second storage space, a height of the first slot wall in a first direction is greater than a height of the second slot wall in the first direction.
